(19) United States
(12) Patent Application Publication
(10) Pub. No.: US 2014/0311161 A1
(43) Pub. Date: Oct. 23, 2014

(54) METHOD FOR CREATING A CONNECTING ELEMENT POSITIONED BETWEEN TWO COMPONENTS OF A STRUCTURE, CONNECTING ELEMENT AND BYPASS TURBOJET ENGINE COMPRISING SUCH A CONNECTING ELEMENT

(71) Applicant: SNECMA, Paris (FR)

(72) Inventors: Francois Robert Bellabal, Fontainebleau (FR); Eric De Vulpillieres, Paris (FR)

(73) Assignee: SNECMA, Paris (FR)

(21) Appl. No.: 14/362,267

(22) PCT Filed: Dec. 10, 2012
(86) PCT No.: PCT/FR2012/052865

§ 371 Date: Jun. 2, 2014

(30) Foreign Application Priority Data
Dec. 8, 2011 (FR) 1161331

(51) Int. Cl. F02C 7/20

(52) U.S. Cl. CPC F02C 7/20
USPC 60/796; 29/888

(57) ABSTRACT

A method for creating a connecting element, arranged between two components of a structure, or a turbojet engine structure, which is subjected to compressive and/or tensile loadings and which includes a hollow shaft immersed, at least partially, in a stream of air flowing between the two components, the method including: dimensioning a width of the main cross section associated with the shaft of the connecting element in a direction orthogonal to the longitudinal axis of the shaft according to desired mechanical strength and desired mass, and according to characteristics of the airstream; and working an external surface of the shaft of the connecting element, at least over part of this surface, to give it a surface finish with an arithmetic mean roughness at least equal to 20 microns, to reduce drag of the connecting element thus dimensioned by comparison with a smooth connecting element of the same diameter.

The present invention relates to bypass turbojet engines and the members providing the connection between the different components thereof. In particular, the present invention relates to retaining rods ensuring the mechanical behavior of the outer bypass flow duct of bypass turbojet engines.

Although it is well suited to such retaining rods, the present invention is not limited to this application and could also be useful for any other connecting element, immersed in an air stream and subjected to the forces of compression and/or traction.

It is known that a bypass turbojet engine comprises in the known manner:
a hot stream (also denoted the primary stream) generator which extends along a longitudinal axis and which is attached by means of a front fastening and a rear fastening to a suspension strut forming, for example, part of the structure of an aircraft. The front fastening and the rear fastening are respectively fixed to the intermediate casing of a high pressure compressor and to the exhaust casing of the hot stream (or to a structural ring connected to said exhaust casing of the hot stream by means of connecting elements, for example connecting rods);
a bypass fan, of which the axis of rotation merges with the longitudinal axis of the hot stream generator which drives said fan in rotation; and
a nacelle which surrounds the hot stream generator and the bypass fan and which defines an outer bypass duct (also denoted by the English acronym OFD for “Outer Fan Duct”), axisymmetrical relative to the longitudinal axis of the hot stream generator and of annular section around said generator. The nacelle is defined at its upstream end by an air inlet orifice and at its downstream end by an outlet orifice for the bypass stream. The bypass stream compressed by the fan is thus guided to the outside via the OFD.

Moreover, the nacelle of such a bypass turbojet engine is generally fixed to the casing surrounding the fan, by means of an upstream fixing and to the hot stream generator by means of a downstream fixing on a nacelle supporting ring borne by the exhaust casing.

In particular, the connection between the supporting ring and the exhaust casing is obtained by connecting elements passing through the bypass stream. Said connecting elements which operate under compression are dimensioned so as to ensure a predetermined resistance to buckling. They may be in the form of connecting rods with a tubular shaft connected, on the one hand, to the supporting ring and, on the other hand, to the exhaust casing which permits a significant reduction in the mass associated with said connection. In this last case, the connection is provided by a group of connecting rods, generally formed from six or eight connecting rods which may be aligned in pairs and attached at six or eight points to the supporting ring. Clevises provided on the exhaust casing permit the attachment of the longitudinal ends of the connecting rods thereto.

It is also known that the interaction of the bypass stream and the connecting rods which pass through the bypass stream causes significant pressure losses which impair the aerodynamic performances of the turbojet engine. More specifically, when the tubular shaft of the connecting rods is of circular section, the premature separation of the outer layer of the external surface of the shaft causes a significant recirculation of the flow downstream of the front surface of said shaft.

Also, in order to reduce the pressure losses caused by the interaction between the connecting rods and the bypass stream, it is known:
either to reduce the diameter of the tubular connecting rod shaft of circular section (and thus of its maximum cross section). However, the reduction in diameter of the shaft requires a reinforcement of the tubular wall thereof by increasing the thickness thereof in order to provide the same resistance to buckling as a shaft of greater diameter. More specifically, such a reinforcement causes a significant increase in the mass of the connecting rods, which may not be desirable;
or to profile the shaft of the connecting rods to reduce the resulting drag thereof. A hollow elliptical cross section of the shaft of the connecting rods has proved to be the best compromise between the mass and the aerodynamic behavior of the connecting rods. However, the production of a hollow elliptical shaft has proved to be complex and thus costly. Moreover, the ball joints at the ends of the connecting rods, designed to be mounted on the corresponding devises of the exhaust casing, are generally screwed into appropriate bores of the profiled shaft, such that said shaft remains free to rotate about its longitudinal axis. In this last case, it becomes difficult to control the orientation of the profile of the shaft. An unsuitable orientation of the shaft relative to the flow direction of the bypass stream—even the appearance of the phenomenon of aeroelastic instability (also denoted as the flutter effect) which is liable to lead to a rupture of the connecting rods—may actually be observed, thus substantially impairing the performance of the turbojet engine.

The subject of the present invention is to remedy said drawbacks and, in particular, to reduce the mass of the connecting elements and/or the pressure losses created by the interaction of the air stream and connecting elements when said connecting elements are immersed in an air flow.

To this end, according to the invention, the method for producing a connecting element arranged between two components of a structure, in particular of a turbojet engine, which is subjected to the forces of compression and/or traction and which is formed by a longitudinal shaft immersed at least partially in an air stream flowing between the two components, having a Reynolds number greater than 10⁴, is notable in that it comprises the following steps:
the width of the maximum cross section associated with the shaft of the connecting element is dimensioned, in a direction at right angles to the longitudinal axis of the shaft, as a function of the desired mechanical resistance and the mass and the characteristics of the air stream; and
the external surface of the shaft of the connecting element is machined over at least one part, to apply thereto a surface state, the average arithmetical roughness being at least equal to 20 micrometers so as to reduce the drag of the connecting element thus dimensioned relative to the drag produced by a smooth shaft of the same dimensions.

Hereinafter, “maximum cross section” is understood as the surface of the shaft of the connecting element projected at right angles on a plane at right angles to the flow direction of the air stream.

More particularly, the degree of roughness Ra/D is selected to be between 10⁻⁴ and 10⁻¹ for a Reynolds number ranging between 4×10⁴ and 3×10⁵.

The document U.S. Pat. No. 4,636,669 which relates to a fan with crosspieces connecting the hub to a casing, swept by the air driven by the blades of the fan, is known. The crosspieces are rough. However, the Reynolds number of the flow around the crosspieces for this type of machine is much lower than that of machines in the category of turbojet engines. It is at a ratio of 1 to 60. The mechanical and aerodynamic conditions are not comparable.

The present invention also relates to a connecting element designed to be arranged between two components of a structure, said connecting element being subjected to the forces of compression and/or traction and being formed by a hollow longitudinal shaft, immersed at least partially in an air stream flowing between the two components and which is noteworthy:
in that the width of the maximum cross section associated with the shaft of the connecting element in a direction at right angles to the longitudinal axis of the shaft is at least equal to 20 millimeters; and
in that at least one part, preferably the entirety, of the external surface of the shaft of the connecting element has an average arithmetical roughness Ra at least equal to 20 micrometers.

Thus, due to the invention, the roughness of the external surface of the shaft of the connecting element increases the turbulence of the flow of the air stream in the immediate vicinity of the external surface, which results in slowing down the separation of the outer layer (the depression created downstream of the connecting element being reduced) and substantially reducing the form drag of the connecting element. This markedly improves the gain in terms of pressure loss.

In other words, the roughness of the connecting element makes it possible to slow down the separation of the outer layer. More specifically, the Reynolds number Re—which characterizes the flow of the air stream (in particular the nature of its state, namely laminar, transitory or turbulent)—is proportional to a characteristic dimension of the connecting element (for example its diameter when it is of circular section), such that the higher this characteristic dimension, the higher the associated Reynolds number Re. More specifically, it has been demonstrated that the gain in terms of pressure loss obtained by slowing down the separation of the outer layer is greater, the higher the Reynolds number of a flow around an object.

The great advantage of the applicant has thus been to determine a suitable surface state of the connecting element, providing it with a roughness which slows down the separation of the associated outer layer to a maximum extent, so as to optimize the coefficient of form drag of the connecting element. Thus, the applicant has countered current preconceptions, according to which it is desirable to obtain an external surface of the connecting element which is as smooth as possible to reduce the form drag.

In this manner, due to the invention, it is possible to reduce the mass of a tubular connecting element by increasing its cross section and reducing the thickness of its lateral wall (whilst meeting the required criteria of resistance to buckling), the associated increase in pressure loss being compensated by a reduction in the coefficient of form drag of the connecting element obtained by optimizing the roughness of the external surface thereof.

By optimizing the association of the Reynolds number Re of the air stream with the roughness of the external surface of the connecting element, the pressure loss may be reduced by up to 60% relative to a connecting element having a characteristic dimension equivalent to a smooth surface.

Advantageously, to obtain the aforementioned roughness, the external surface of the shaft may belong, at least partially, to the following group of surfaces:
abrasive surface;
cellular surface;
surface provided with microballs
longitudinally grooved surface
surface comprising longitudinal facets.

It is noteworthy that a combination of these different surfaces may also be conceivable.

Moreover, the ratio of the width of the maximum cross section associated with the shaft in the direction at right angles to the longitudinal axis of the shaft on the aerodynamic chord of the shaft preferably ranges between 0.25 and 1.05.

In particular, the cross section of the shaft may advantageously be circular or elliptical.

Preferably, the shaft of the connecting element is tubular and has a lateral wall thickness at least equal to 0.8 mm and at most equal to 5 mm.

Thus in the case of a connecting element shaft of circular cross section:
if at the outset, the external diameter of the shaft is large (for example 40 mm), the passage from a smooth external surface to a rough external surface according to the invention makes it possible to reduce markedly the aerodynamic interference caused by the connecting element (up to 60% pressure loss at least) without modifying the original external diameter thereof;
if at the outset, the external diameter of the shaft is small (for example 20 mm), the increase in the diameter of the shaft (for example from 20 mm to 40 mm) combined with the treatment of the external surface of the shaft from smooth to rough, permit a reduction in the thickness of the lateral wall of the shaft which is accompanied by a reduction in the mass thereof (with the same resistance to buckling) without impairing (or only very slightly impairing) the coefficient of form drag of the connecting element.

Relative to a tubular connecting element profiled with an elliptical cross section, the connecting element of circular section of the invention has, in particular, the following advantages:
the mass and/or associated pressure losses are reduced;
the manufacture is greatly facilitated which substantially reduces its production cost;
there is no risk of aeroelastic instability, so that it is not necessary to block the shaft in rotation.

According to a first numerical example, provided simply by way of an illustrative but non-limiting example, the width of the maximum cross section associated with the shaft in the direction at right angles to the longitudinal axis of the shaft is equal to 40 millimeters and the external surface of said shaft has, at least partially, an average arithmetical roughness Ra equal to 70 micrometers.

Similarly, according to a second numerical example according to the invention, the width of the maximum cross section associated with the shaft in the direction at right angles to the longitudinal axis of the shaft is equal to 30 millimeters and the external surface of said shaft has, at least partially, an average arithmetical roughness Ra equal to 100 micrometers.

In an embodiment according to the present invention, the connecting element is in the form of a connecting rod which comprises fastening means, preferably a ball joint, at each of its longitudinal ends.

Moreover, the present invention further relates to a bypass turbojet engine comprising:
a hot stream generator extending along a longitudinal axis Z-Z and comprising an exhaust casing of the hot stream in the vicinity of its downstream end;
a bypass fan driven in rotation by the hot stream generator;
a nacelle which at least partially surrounds the hot stream generator and the bypass fan and which defines an outer duct for the bypass stream; and
a supporting ring for the nacelle which is borne by connecting elements fastened to the exhaust casing and immersed, at least partially, in the bypass stream of the outer duct, which is noteworthy in that said connecting elements are of the type described above.

The accompanying figures will show clearly how the invention may be implemented. In the figures, identical reference numerals denote similar elements.

FIG. 1 is a stylized axial section of a bypass turbojet engine according to the present invention.

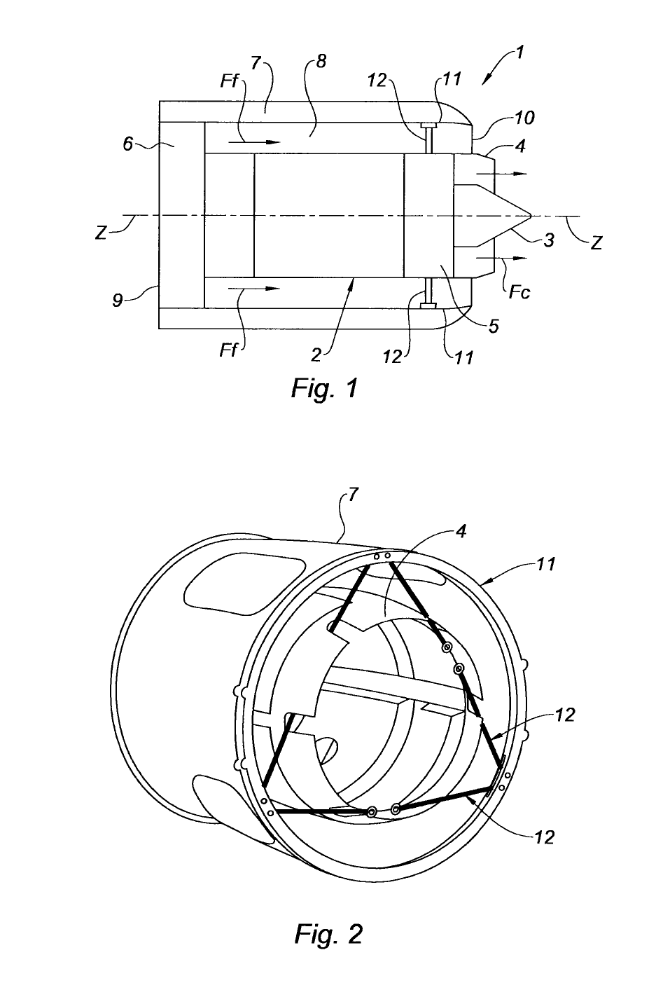

FIG. 2 shows partially, in a schematic perspective view, the rear of the turbojet engine in FIG. 1.

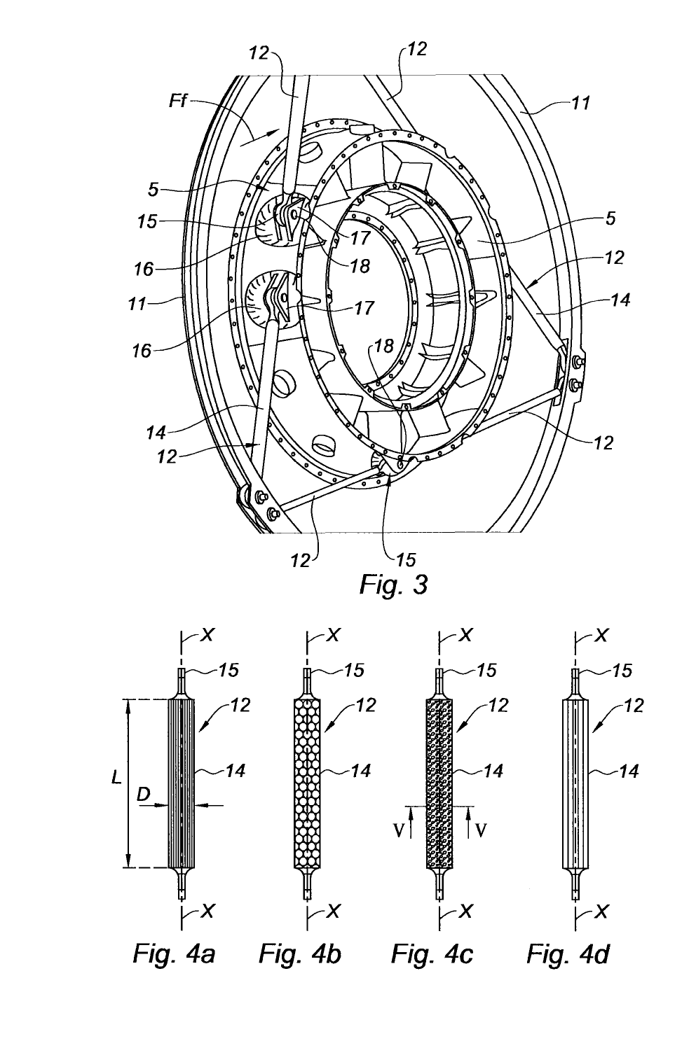

FIG. 3 shows partially, in a schematic perspective view, connecting rods according to the invention providing the connection of the exhaust casing and the supporting ring of the nacelle of the turbojet engine of FIG. 1.

FIGS. 4A to 4D show schematically in an elevation, a connecting rod according to the invention of which the external surface is respectively grooved (FIG. 4A), cellular (FIG. 4B), provided with microballs (FIG. 4C) and faceted (FIG. 4D).

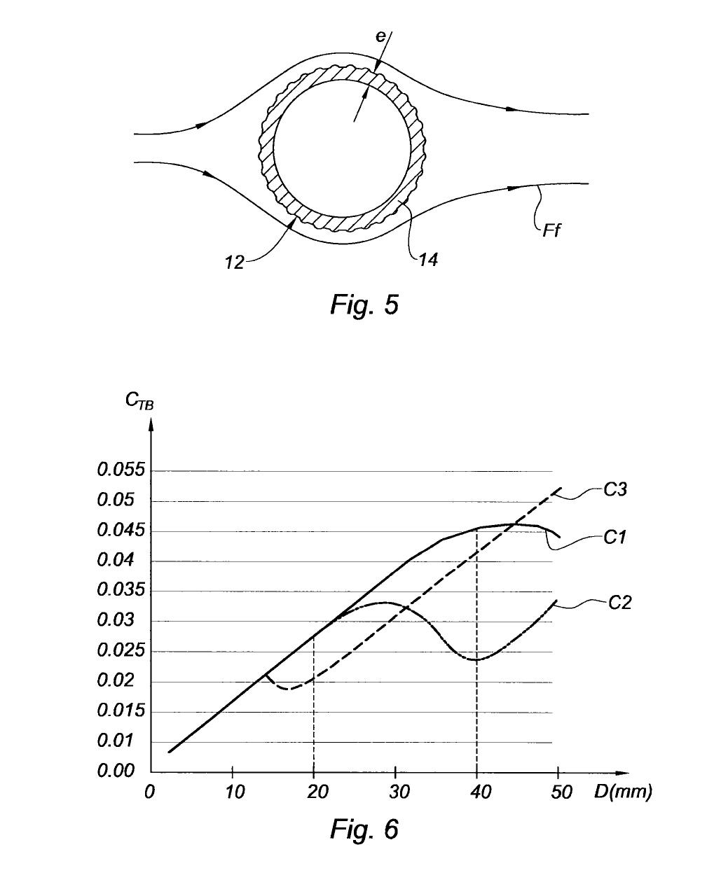

FIG. 5 is an enlarged schematic cross section of the connecting rod of FIG. 4C, along the line V-V.

FIG. 6 illustrates a diagram which shows the development of the coefficient of drag of a connecting rod as a function of the diameter thereof, for different degrees of roughness of its external surface.

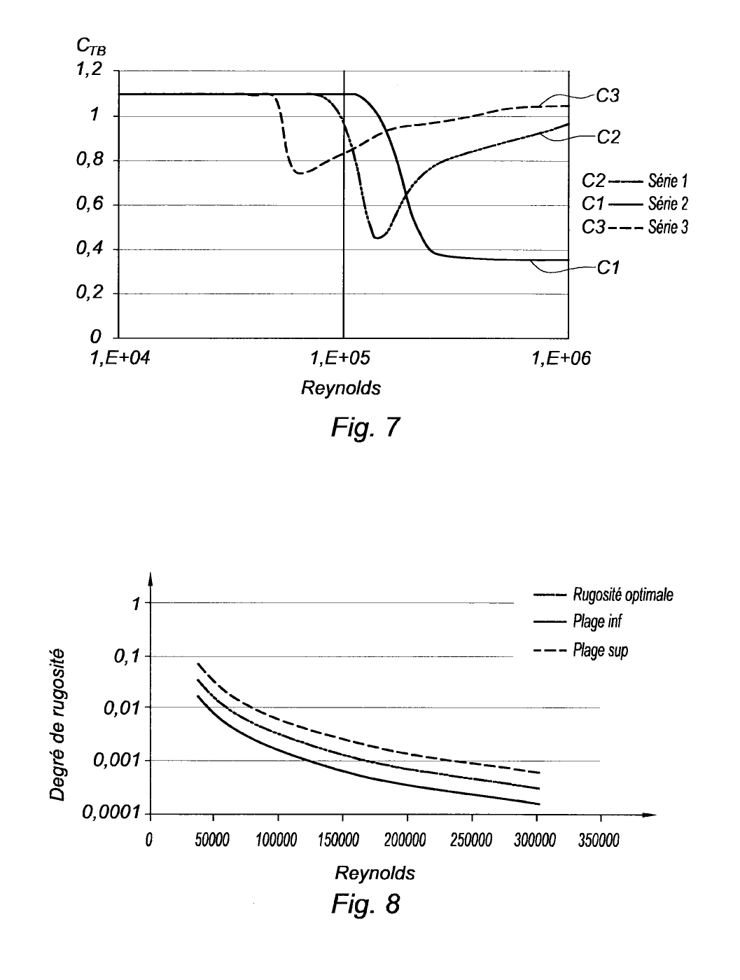

FIG. 7 illustrates a diagram which shows the development of the coefficient of drag of a connecting rod as a function of the Reynolds number for different degrees of roughness.

FIG. 8 illustrates a diagram which shows the development of the degree of roughness as a function of the Reynolds number.

In FIG. 1, shown in a stylized manner is a bypass turbojet engine 1 which comprises in the usual manner:
a hot stream generator 2 (also denoted the primary stream and symbolized by the arrow Fc) which extends along a longitudinal axis Z-Z and is terminated at its downstream end by a rear cone 3 surrounded, at least partially, by a hot stream nozzle 4. The hot stream generator 2 also comprises an exhaust casing 5 forming part of the structure thereof, in the vicinity of its downstream end. The hot stream Fc thus passes through the generator 2 to be ejected to the exterior thereof via the nozzle 4;
a fan 6 for the bypass stream (also denoted as the secondary stream and symbolized by the arrow Ff) of which the axis of rotation merges with the longitudinal axis Z-Z of the hot stream generator 2 which drives it in rotation; and
a nacelle 7 which surrounds the hot stream generator 2 and the fan 6 and which defines an outer bypass duct 8 OFD, axisymmetrical relative to the longitudinal axis Z-Z of the hot stream generator 2 and of annular section around said generator. The nacelle 7 is defined at its upstream end by an air inlet orifice 9 and at its downstream end by an outlet orifice 10 for the bypass stream Ff. Said bypass stream Ff, compressed by the fan 6, is guided via the outer duct 8 and expelled therefrom in the region of the outlet orifice 10.

Moreover, as FIGS. 1 to 3 show, the nacelle 7 is attached to the hot stream generator 2 via an upstream fixing on the casing surrounding the fan 6 and by a downstream fixing on a supporting ring 11 surrounding the exhaust casing 5 which bears said casing. The connection between the supporting ring 11 and the exhaust casing 5 is implemented by a group of six metal connecting rods 12 passing through the bypass stream Ff, each of the connecting rods 12 being connected to the supporting ring 11 and to the exhaust casing 5. The forces associated with retaining the supporting ring 11 are thus transmitted to the exhaust casing 5 via the connecting rods 12.

As illustrated in FIGS. 3 and 4, each connecting rod comprises a longitudinal tubular shaft 14 of circular section having a length L, ranging for example between 300 mm and 700 mm, which comprises at each of its two ends, a fastening ball joint 15. The lateral wall of the tubular shaft 14 has a thickness e (FIG. 5).

The fastening ball joint 15 may comprise a threaded cylindrical foot (not shown) designed to be screwed into the longitudinal channel of the shaft 14 provided with a complementary thread.

One of the two ball joints 15 of each connecting rod 12 is mounted on a clevis 16 which forms part of the exhaust casing 5 and which comprises two bored lugs 17, between which is arranged a ball joint 15. The clevis 16 and the associated ball joint 15 are thus traversed by a screw 18, so as to define a pivot connection.

As shown in FIG. 3, the connecting rods 12 are arranged in pairs, substantially tangentially to the exhaust casing 5 and thus substantially define a triangle, the apexes thereof being located on the supporting ring 11.

According to the invention, in order to reduce the form drag produced by the interaction of the bypass stream Ff and each of the connecting rods 12, the width D of the maximum cross section associated with the shaft 14 of the connecting rods 12—said width D being defined in a direction at right angles to the longitudinal axis X-X of said shaft 14—is selected to be at least equal to 20 millimeters. It should be noted that in the disclosed example, the width D corresponds to the diameter of the shaft 14 of circular section.

Moreover, as FIGS. 4A to 4B show, the entire external surface of the shaft 14 of each connecting rod 12 has an average arithmetical roughness Ra at least equal to 20 micrometers and preferably at most equal to 200 micrometers.

By definition, the average arithmetical roughness Ra representing the average arithmetical separation between the rough surface of the shaft 14 and the same surface which would be perfectly smooth, is obtained using the relation

$$Ra = \frac{1}{n} {\sum }_{i = 1}^{ij} \vert {y}_{i} \vert$$

where yᵢ represents the separation in distance relative to a smooth surface.

As a variant, one or more portions of the external surface of the shaft—for example defined in the form of two separate strips extending over the length of the shaft and arranged on the downstream part thereof in the vicinity of a diameter D of the shaft taken at right angles to the flow direction of the air stream Ff—could have a grain size distribution at least equal to 20 micrometers, the remainder of the external surface being smooth.

In addition, in order to provide such an average roughness Ra, the external surface of the shaft 14 of each connecting rod 12, according to the invention and as FIGS. 4A to 4B show, may belong to the following non-exhaustive group of surfaces:
a surface comprising parallel pairs of longitudinal grooves (FIG. 4A);
a surface formed from a plurality of cells (FIG. 4B);
a surface provided with microballs obtained by the projection of microballs, for example made of glass (FIG. 4C);
a surface comprising longitudinal facets (FIG. 4D);
an abrasive surface (not shown in the figures).

By means of the invention, the application on the external surface of the shaft 14 of a surface state, the associated roughness thereof having an average arithmetical value Ra at least equal to 20 micrometers, produces further turbulence in the immediate vicinity of the external surface of the shaft 14. This slows down the separation of the external layer (illustration thereof being shown in FIG. 5) thereby causing a reduction in the low pressure downstream of the shaft 14. The form drag of the connecting element is reduced and the gain in terms of associated pressure loss is improved.

More specifically, the Reynolds number Re of the flow of the bypass stream Ff is defined by the following relation:

$${R}_{c} = \frac{ρ \cdot D \cdot V}{μ}$$

in which:
ρ is the density of the bypass stream Ff;
D is the external diameter of the shaft 14 of the connecting rod 12;
V is the flow velocity of the bypass stream Ff in the outer duct 8; and
μ is the dynamic viscosity of the bypass stream Ff circulating in the outer duct 8.

For example, a flow of the bypass stream Ff around the connecting rods 12 when the turbojet engine 1 is mounted on an aircraft flying at Mach 0.8 at 40,000 feet (i.e. approximately 12 km), results in:
the density ρ of the bypass stream Ff such that ρ=0.44 kg/m³;
the flow velocity V of the bypass stream Ff in the outer duct 8 such that V=138 m/s;
the dynamic viscosity p of the bypass stream Ff such that μ=1·75·10⁻⁵ kg/m·s; and
the Reynolds number on the associated chord equal to

$$\frac{ρ \cdot V}{μ} = 3 , 5 \cdot {10}^{- 3} {m}^{- 1} .$$

As mentioned above, the higher the Reynolds number associated with the flow of the bypass stream Ff around the connecting rod 12, the greater the gain in terms of pressure loss obtained by slowing down the separation of the corresponding outer layer.

In other words, by slowing down the separation of the outer layer which is formed in the vicinity of the external surface of the shaft 14, it is possible to reduce the pressure loss resulting from the interaction of the air stream and the shaft 14.

To achieve this, the applicant has thus determined a suitable surface state of the connecting element—namely an associated roughness having an average arithmetical value Ra at least equal to 20 micrometers—slowing down the separation of the associated outer layer so as to optimize the coefficient of form drag of the connecting element.

In FIG. 6 is shown the development of the coefficient of form drag C_{TB} of a connecting rod 12 as a function of the diameter D thereof, for three separate values of roughness of its external surface and in typical conditions of cruise flight. Thus, the curves C1 to C3 correspond to a smooth external surface state of the shaft 14 (the ratio Ra/D is equal to 10⁻⁵) rough (Ra/D is equal to 2·10⁻³) and very rough (Ra/D is equal to 7·10⁻³). The ratio Ra/D corresponds to the degree of roughness.

From the diagram of FIG. 6 it is possible to deduce, for example, that for a diameter of the shaft 14 equal to 40 mm, the coefficient of form drag of the connecting rod 12 is markedly lower for a rough surface state (and not smooth or very rough).

By way of a purely illustrative non-limiting example:
in a first example, the width D of the shaft 14 is equal to 40 millimeters and the external surface of the shaft 14 has, in its entirety, a roughness Ra equal to 70 micrometers; and
in a second example, the width D of the shaft 14 is equal to 30 millimeters and the external surface of the shaft 14 has a roughness Ra equal to 100 micrometers.

More generally, taking account of the fact that for a given degree of roughness Ra/D, the coefficient of drag of cylinders C_{TB} varies as a function of the Reynolds number Re and said coefficient C_{TB} passes through a minimum value when the Reynolds number increases from 10,000 to 300,000, see FIG. 7 for two degrees of roughness C2, C3 and a smooth surface C1, the Reynolds numbers for which the drag is minimal are determined for a range of degrees of roughness Ra/D. Thus a relation between the Reynolds numbers and the optimal degree of roughness has been established. The curve of FIG. 8 shows the variation in the optimal degree of roughness Ra/D as a function of the Reynolds number.

This variation substantially follows the law Y=1 E+08X^{-2,112} between the Reynolds number X and the degree of roughness Y. Advantageously, for a given diameter D of the connecting rod and a Reynolds number, it is thus possible to determine the optimal degree of roughness Ra/D from which the optimal degree of roughness Ra is deduced. It is noteworthy that the curve representing the optimal variation in roughness is limited by two parallel curves which define a range of optimal values. Thus, for a Reynolds number ranging from 4×10⁴ and 3×10⁵, the degree of roughness Ra/D is selected between 10⁻⁴ and 10⁻¹.

Moreover, although the present invention has been described with reference to a connecting rod shaft of circular cross section, it is obvious that it also applies to a connecting rod shaft of elliptical cross section and, more generally, to a connecting rod shaft of which the ratio of the width of the maximum cross section associated with the shaft, in a direction at right angles to the longitudinal axis X-X of said shaft, on the aerodynamic chord of the shaft ranges between 0.25 and 1.05.

1-11. (canceled)

12. A method for producing a connecting element arranged between two components of a structure, or of a turbojet engine, which is subjected to forces of compression and/or traction and which includes a longitudinal hollow shaft immersed at least partially in an air stream flowing between the two components having a Reynolds number greater than 10⁴, the method comprising:
dimensioning a width of maximum cross section associated with the shaft of the connecting element, in a direction at right angles to the longitudinal axis of the shaft, as a function of desired mechanical resistance and mass and characteristics of the air stream; and
machining an external surface of the shaft of the connecting element over at least one part, to apply thereto a surface state of which average arithmetical roughness Ra is at least equal to 20 micrometers, to reduce drag of the connecting element thus dimensioned relative to drag produced by a smooth shaft.

13. The method as claimed in claim 12, wherein a degree of the roughness is selected to be between 10⁻⁴ and 10⁻¹ for a Reynolds number ranging between 4×10⁴ and 3×10⁵.

14. A connecting element configured to be arranged between two components of a structure, or of a turbojet engine, the connecting element being subjected to forces of compression and/or traction and including a hollow longitudinal shaft, immersed at least partially in an air stream flowing between the two components having a Reynolds number greater than 10⁴,
wherein
a width of maximum cross section associated with the shaft of the connecting element in a direction at right angles to the longitudinal axis of the shaft is at least equal to 20 millimeters; and
at least one part, or an entirety, of an external surface of the shaft of the connecting element has an average arithmetical roughness at least equal to 20 micrometers.

15. The connecting element as claimed in claim 14, wherein the external surface of the shaft belongs, at least partially, to one of:
an abrasive surface;
a cellular surface;
a surface including microballs;
a longitudinally grooved surface;
a surface including longitudinal facets.

16. The connecting element as claimed in claim 14, wherein a ratio of the width of the maximum cross section associated with the shaft in the direction at right angles to the longitudinal axis of the shaft on an aerodynamic chord of the shaft ranges from 0.25 to 1.05.

17. The connecting element as claimed in claim 16, wherein the cross section of the shaft is circular or elliptical.

18. The connecting element as claimed in claim 14, wherein the shaft of the connecting element is tubular and has a lateral wall thickness at least equal to 0.8 mm and at most equal to 5 mm.

19. The connecting element as claimed in claim 14, wherein the width of the maximum cross section associated with the shaft in the direction at right angles to the longitudinal axis of the shaft is equal to 40 millimeters, and wherein the external surface of the shaft has, at least partially, an average arithmetical roughness equal to 70 micrometers.

20. The connecting element as claimed in claim 14, wherein the width of the maximum cross section associated with the shaft in the direction at right angles to the longitudinal axis of the shaft is equal to 30 millimeters, and wherein the external surface of the shaft has, at least partially, an average arithmetical roughness Ra equal to 100 micrometers.

21. The connecting element as claimed in claim 14, in a form of a connecting rod which comprises fastening means, or a ball joint, at each of its longitudinal ends.

22. A bypass turbojet engine comprising:
a hot stream generator extending along a longitudinal axis and comprising an exhaust casing of the hot stream in a vicinity of its downstream end;
a bypass fan driven in rotation by the hot stream generator;
a nacelle that surrounds at least partially the hot stream generator and the bypass fan and that defines an outer bypass duct;
a supporting ring of the nacelle and of the rear suspension which is borne by connecting elements fastened to the exhaust casing and immersed, at least partially, into the bypass stream of the outer duct;
wherein the connecting elements are of the type according to claim 14.
